(19) United States
(12) Patent Application Publication
(10) Pub. No.: US 2017/0162881 A1
(43) Pub. Date: Jun. 8, 2017

(54) MULTI-FUNCTIONAL POROUS CARBON-SUPPORTED MICROPOROUS INORGANIC MEMBRANES FOR REDOX FLOW BATTERIES

(71) Applicant: University Of Cincinnati, Cincinnati, OH (US)

(72) Inventors: Junhang Dong, Cincinnati, OH (US); Zhi Xu, Cincinnati, OH (US)

(21) Appl. No.: 15/293,385

(22) Filed: Oct. 14, 2016

Related U.S. Application Data
(60) Provisional application No. 62/241,796, filed on Oct. 15, 2015.

(51) Int. Cl. H01M 8/0245; H01M 8/0234; H01M 8/0236; H01M 8/18

(52) U.S. Cl. CPC H01M 8/0245; H01M 8/188; H01M 8/0234; H01M 8/0236

(57) ABSTRACT

A separator for a redox flow battery includes a support layer having a first side, and a zeolite layer formed on the first side of the support layer. The support layer includes a porous substrate that is a carbon substrate or a carbon coated substrate. A redox flow battery includes a first oxidizing reaction chamber, a second reducing reaction chamber, and a separator dividing said first oxidizing reaction chamber and said second reducing reaction chamber. The separator includes a zeolite layer formed onto a support layer. The support layer includes a porous substrate that is a carbon substrate or a carbon coated substrate.

### CROSS-RELATED APPLICATION

The present application claims priority to U.S. Provisional Application No. 62/241,796 filed Oct. 15, 2015, the disclosure of which is hereby incorporated herein by reference in its entirety.

### STATEMENT REGARDING FEDERALLY SPONSORED RESEARCH OR DEVELOPMENT

The present invention was made, at least in part, with support from the U.S. Government and funds identified as grant number CBET-1263860, awarded by the U.S. National Science Foundation. The U.S. Government has certain rights in the present invention.

### TECHNICAL FIELD

The present invention relates generally to inorganic ion exchange membranes and methods of using same and, more specifically, to multi-functional porous carbon-supported microporous inorganic membranes for redox flow batteries.

### BACKGROUND

Redox-flow batteries (RFB) are attracting broad interest for electrical energy storage in solar and wind power systems and large-scale electric grids because of their low-cost, safety and small environmental footprints. The RFB operates on electrode reactions of dissolved red-ox metal ion couples separated by an ion exchange membrane (IEM). The IEM is ideally electronically insulating and highly permeable to the nonreactive ion charge carriers but impermeable to the reactive metal ions. To date, RFBs are mostly based on proton-selective, perfluorinated or non-perfluorinated ionic polymer IEMs. However, in the extremely acidic and oxidizing RFB electrolyte solutions, the polymeric IEMs have common issues of metal ion crossover and material degradation over long term that limit the cell efficiency and the lifetime.

Zeolites are crystalline aluminosilicates with enormous internal surface area, large porosity and uniform pore diameters ranging from 0.3 nm to over 1 nm depending on the specific crystallographic structure. The zeolite framework is formed by [SiO₄] and [AlO₄] tetrahedrons interlinked through corner oxygen ions and large numbers of exchangeable extraframework cations exist in the zeolitic channels as charge compensators for [AlO₄] sites. The pore size and chemical and physical properties of zeolite materials can be fine-tuned by framework isomorphous elemental substitution and extraframework ion exchange during and after synthesis. Over the last few decades, various types of zeolite membranes have been developed for gas and liquid separations based on molecular size discrimination or competitive molecular adsorption-diffusion mechanisms. In recent years, zeolite membranes were also demonstrated for water purification from salt solutions by size-exclusion (steric) effect because metal ions are bonded with surrounding water molecules to form hydration shells making the hydrated ion size too large to enter the zeolitic pores. The kinetic size of hydrated metal ion increases with the ion charge density, i.e., electrical charge per volume of the ion. Unlike metal ions, protons in aqueous solutions exists in the form of H₃O⁺(hydronium) with three identical “H—O” bonds making it a polyatomic ion with charge density too small to form a definable hydration shell. The kinetic size of the H₃O⁺is thus much smaller than the hydrated multivalent metal cations commonly involved in various RFB systems.

To reduce the ohmic resistance of the IEM for high RFB energy efficiency, the inorganic IEMs are desired to have a very small thickness. However, unlike conventional polymeric IEMs, which have a flexible structure to withstand shape changes under stress, the very thin inorganic IEMs are normally extremely fragile and thus must be supported on thick rigid porous substrates, e.g., porous ceramic and metal supports, for practical uses. The thick porous ceramic and metal substrates (which are electrochemically inert) not only add significant mass transfer and ion conduction resistances to the battery but also increase the volume and weight of the membrane-electrode assembly (MEA) that decrease the battery energy efficiency and causes problems in transportation and applications.

### SUMMARY

The present invention provides a composite structure which is suitable as a separator in an RFB system. The composite is an ion exchange membrane which incorporates a layer of zeolite on a support layer. The support layer is a porous carbon substrates or a carbon coated substrate. The carbon substrates can be electronically conductive with catalytic activity for the redox reactions or be used solely as very light mechanical support that is catalytically inactive.

Further, an embodiment of the present invention provides a redox flow battery incorporating, as a separator, a zeolite layer. The zeolite layer may be supported on a porous carbon substrates or a carbon coated substrate.

The present invention will be further appreciated in light of the following detailed description and drawings in which:

### BRIEF DESCRIPTION OF THE DRAWINGS

FIG. 1 is a diagrammatic depiction of a composite inorganic ion exchange membrane according to an embodiment of the present invention.

FIG. 2 is a diagrammatic depiction of a redox flow battery according to an embodiment of the present invention.

FIGS. 3A-3F are SEM images of a composite membrane inorganic ion exchange membrane according to an embodiment of the present invention.

FIGS. 3A and 3B are SEM images of a cross-section view and a surface view, respectively, of the zeolite nanoparticle-seeded carbon support.

FIGS. 3C and 3D are SEM images of cross-section views of the ZSM-5 zeolite membrane obtained by secondary growth on the carbon support.

FIGS. 3E and 3F are SEM images of views of the surface of the membrane of FIGS. 3C and 3D.

FIGS. 4A and 4B are a cross-section view and a surface view, respectively, of a carbon cloth coated with particles made of graphite nanoplates.

FIG. 5 is a graph comparing the total system resistances of a VRFB with no IEM, a Nafion® 117 IEM, and a composite inorganic ion exchange membrane according to an embodiment of the present invention.

FIG. 6 is a graph of the charge discharge curve of a VRFB equipped with a composite inorganic ion exchange membrane.

### DETAILED DESCRIPTION

Embodiments of the present invention are directed to a zeolite membrane supported on a carbon substrate or a carbon coated substrate to form a separator for use in a redox flow battery system. Further embodiments of the present invention are directed to a redox flow battery system including a carbon-supported zeolite separator as the inorganic ion exchange membrane.

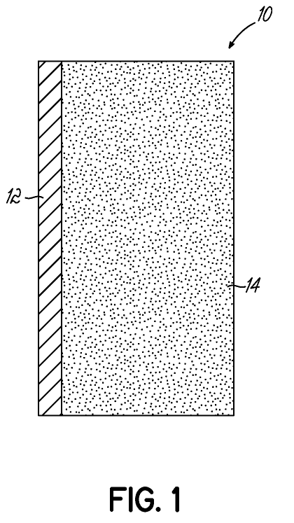

With reference to FIG. 1, in one embodiment, a composite inorganic ion exchange membrane 10 includes a zeolite layer 12 formed on a porous support layer 14. The zeolite layer 12 is an inorganic microporous IEM layer. Suitable materials for the zeolite layer 12 include, without limitation, an aluminum-containing MFI type zeolite, such as ZSM-5 zeolite, and other zeolite types that can be made with silicon (Si) to aluminum (Al) atomic ratios of greater than 5. The thickness of the composite inorganic ion exchange membrane 10, which includes the macroporous support layer 14 and the supported zeolite layer 12, may range from 0.25 to 8 millimeter (mm) for example.

The zeolite layer 12 has a ratio of silicon to aluminum atoms that can be varied. For use in the present invention, the ratio of silicon to aluminum must be greater than five to one and up to a ratio containing no aluminum whatsoever. Generally, the silicon to aluminum ratio will range from about 10 to 100, or about 10 to 50, or about 20 to 40. A silicon to aluminum ratio much higher than 100 results in low exchangeable proton concentration in the zeolitic pores after ion exchange in acidic electrolyte solutions that leads to low ionic conductivity and hence low energy efficiency of the battery. On the contrary, when the silicon to aluminum ratio is much lower than 10, severe dealumination of the zeolite framework in acidic solutions may cause a collapse of the zeolite crystal structure over time and consequently lower the battery lifetime.

The thickness of the zeolite layer 12 may be from about 0.5 to about 100 μm. Generally, it will be 1 to 50 μm, with about 1 to 10 μm in certain situations. The pore size of the zeolite layer should be from about 0.3 to about 1.0 nanometer (nm) and generally from 0.30 nm to 0.60 nm.

The porous support layer 14 may include a substrate that is entirely made of carbon or is made of other porous materials coated with carbon. A carbon substrate may also be coated with carbon. Porous materials suitable for use as a substrate in the porous support layer 14 include, without limitation, metals, ceramics, metalloids, and polymers. The internal surfaces of the porous substrate may be coated with carbon materials. Carbon materials suitable for coating a porous substrate include, without limitation, activated carbon, graphite nanoplates, carbon nanotubes, carbon nanofibers, and graphene. The porous substrate may be in the form of, for example, flat sheets, discs, tubes, rods, and multi-channel monoliths. For example, in various embodiments, the porosity is formed by carbon fibers, with or without coating additional carbon materials, or by packed carbon particles, with or without coating additional carbon materials. The pore structure of the porous support layer 14 can be either symmetrical or asymmetrical. The pore size of the porous support layer 14 may, for example, range from about 5 to 100 micrometer (μm).

In an aspect of the present invention, the porous support layer 14 may provide more than one function when used in combination with a separator in a redox flow battery. The porous support layer 14 functions as a physical support that provides mechanical strength to prevent the fragile inorganic ion separator or IEM (i.e., the zeolite layer) from being damaged during fabrication, cell assembly, and operation of the redox flow battery. Additionally, the porous support layer 14 acts as a flow diffusion layer for distributing electrolyte solution over the electrodes and the inorganic IEM and for facilitating effective mass transport between the electrode surface and solution flows. Further, in an embodiment, the porous support layer 14 can be either catalytically inactive and be used solely as very light mechanical support or electronically conductive with catalytic activity for the redox reactions. In other words, the porous support layer 14 may act as a carbon electrode to catalyze the electrochemical (cathodic or anodic) reactions. Moreover, in an embodiment, the porous support layer 14 may act as a porous host for loading (e.g., internal surface coating) of electrochemical catalysts for enhanced electrochemical reaction kinetics. Examples of the electrochemical catalysts that may be used include metals (e.g., Au, Ag, Pt, Pd, and Pb, etc.) and metal oxide catalysts. Thus, the porous support layer 14 may simultaneously function as one or more of a physical support, a flow diffusion layer, an electrode, and a host for catalysts.

For example, in an embodiment, a ZSM-5 zeolite membrane may be synthesized on large pore carbon cloth (i.e., a porous carbon substrate) coated with graphite nanoplate particles. The carbon cloth supported ZSM-5 membrane is electronically insulating and highly proton conductive in vanadium redox flow battery (“VRFB”) electrolyte solutions. The large pore carbon cloth coated with graphite nanoplate particles is dual functional in the VRFB structure, namely as a substrate providing mechanical support for the ZSM-5 zeolite membrane and as part of the electrode catalyzing cathodic or anodic electrochemical reactions. As shown in Example 1 below, the ZSM-5 zeolite membrane exhibits good proton to vanadyl ion permselectivity and much lower Ohmic resistance (0.2 Ω·cm²) than a conventional Nafion® 117 membrane (1.6 Ω·cm²) in the VRFB electrolyte solution. The charge-discharge operation test of the VRFB demonstrated that the coated carbon cloth supported ZSM-5 membrane is fully functional as ion separator.

The zeolite layer 12 can be formed on the porous support layer 14 using a variety of techniques such as, for example, slip-casting or dip-coating using suspensions of the zeolite particles. The zeolite layer 12 may also be formed on the porous support layer 14 by electrostatic layer-by-layer coating or spray-drying processes. Further, the zeolite layer 12 may be synthesized on the porous support layer 14 by an in-situ crystallization method, by seeded secondary growth method, or by precursor gel conversion techniques in vapor phase.

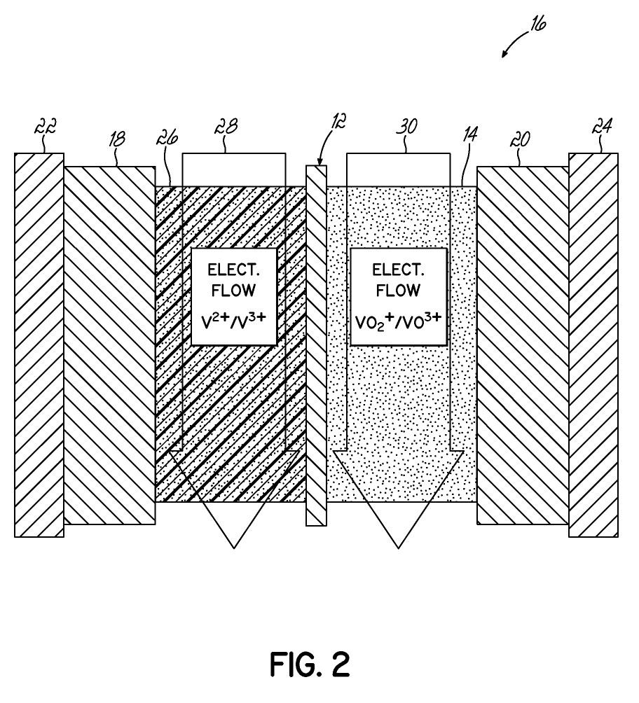

With reference to FIG. 2, the composite inorganic ion exchange membrane 10 can be used as a separator in a vanadium redox flow battery 16. The VRFB 16 includes the composite inorganic ion exchange membrane 10 as a separator positioned between two dense carbon graphite current collectors 18 and 20. The current collectors 18 and 20 are in turn attached to metal collecting plates 22 and 24. The metal collecting plates 22 and 24 may be, for example, copper or stainless steel. An electrode 26 is positioned between the current collector 18 and the separator 10. The electrode 26 may be, for example, carbon felt or a metal loaded carbon felt. In an embodiment, the porous support layer 14 acts as an electrode between the current collector 20 and the zeolite layer 12 of the separator 10. In an embodiment, an additional component may be positioned between the porous support layer 14 and the current collector 20 to improve the contact therebetween without the additional component acting as an electrode. Alternatively, in an embodiment where the porous support layer 14 does not act as an electrode, an additional electrode, similar to the electrode 26, may be included. Collectively, the separator 10 and the electrode 26 form a membrane-electrode assembly positioned between the current collectors 18 and 20. Between the separator 10 and the respective current collectors 18 and 20 are flow paths or chambers 28 and 30 for the oxidizing and reducing metal ion reactants.

Although a VRFB is described, it should be recognized that a composite ion exchange membrane according to the present invention may be used in other redox flow batteries. Non-limiting examples of other RFBs include a zinc-cerium battery, a zinc-bromine battery, an iron-chromium battery, a vanadium-bromine battery, a sodium-polysulfide-bromine battery, and an all-vanadium battery.

In order to facilitate a more complete understanding of the embodiments of the invention, the following non-limiting example is provided.

### Example 1

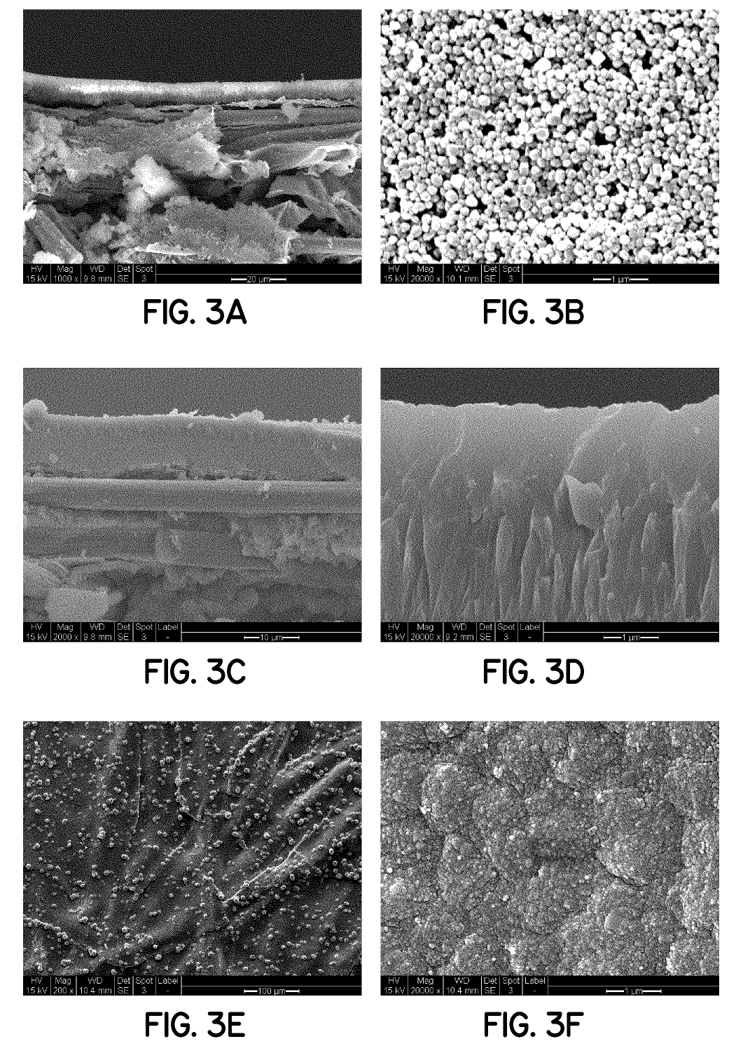

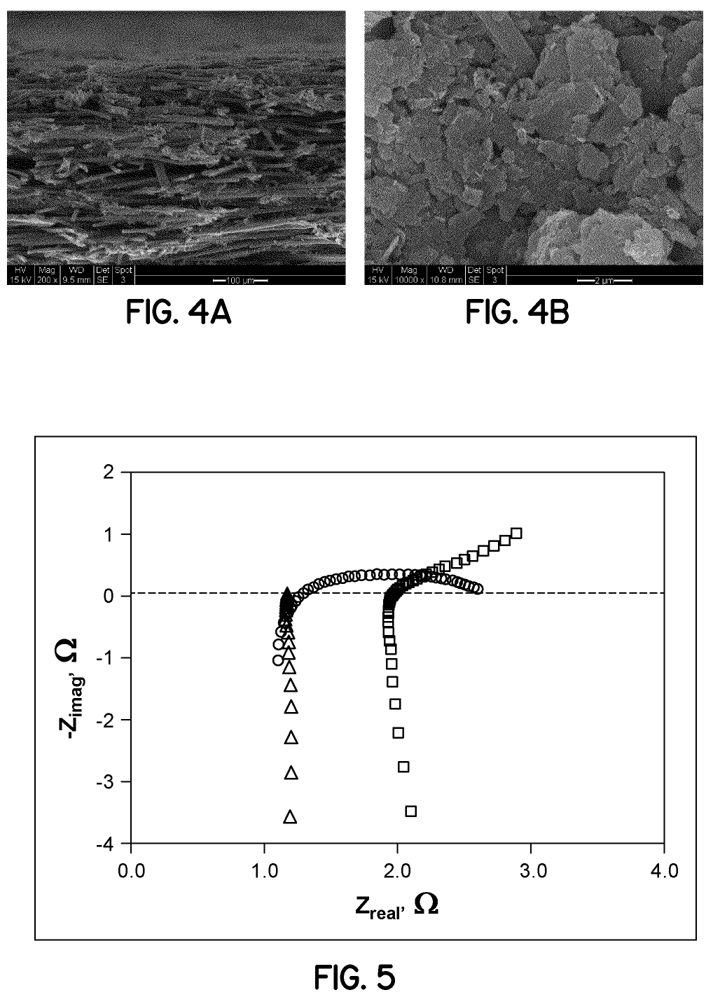

Composite Membrane Preparation and Characterization. A carbon-supported ZSM-5 membrane was synthesized on a carbon substrate by seeded secondary growth method. The carbon substrate was a large pore carbon cloth (pore size of about 50 to 100 mm) with its surface coated with particles made of graphite nanoplates. FIGS. 4A and 4B show the large pore carbon cloth coated with particles made of graphite nanoplates. FIGS. 3A-3F shows an aluminum-containing MFI type zeolite (ZSM-5; Si/Al ratio of about 35) membrane supported on a graphite nanoparticle coated carbon cloth. FIGS. 3A and 3B are a cross-section view and a surface view, respectively, of the zeolite nanoparticle-seeded carbon support. FIGS. 3C and 3D are cross-section views of the ZSM-5 zeolite membrane obtained by secondary growth on the carbon support, while FIGS. 3E and 3F show view of the surface of the membrane. The carbon supported ZSM-5 zeolite membrane has been previously tested to have a proton/vanadyl ion (H⁺/VO²⁺) transport selectivity value of greater than 210, which is much better than that of a Nafion® 117 membrane (H⁺/VO²⁺transport selectivity of about 20).

Single Cell VRFB Preparation and Characterization. A single cell VRFB was constructed by sandwiching the carbon-supported ZSM-5 membrane between two carbon felt components to form a membrane-electrode assembly. The carbon felt component on the side of the carbon cloth support (opposite that of the ZSM-5 zeolite membrane) was one tenth of the thickness of the carbon felt component on the side of the ZSM-5 zeolite membrane. The thinner carbon felt component was used for improving the contact between the carbon cloth support and the dense graphite disc current collectors and did not act as electrode.

The carbon-supported ZSM-5 membrane and electrodes were disc-shaped with a diameter of 2.5 cm, which gave an active working area of 2.0 cm² after excluding the edge area covered by seals. The membrane-electrode assembly was then compressed and held between two dense graphite disc current collectors. The outer surfaces of the dense graphite disc current collectors were attached to two copper sheets, which were used as battery terminal connectors.

A Gamry Reference-600™ unit and a multichannel battery analyzer (BST8-3, 8-Channel Battery Analyzer, MTI Corp.) were employed for the battery operation tests. FIG. 5 shows the results of electrochemical impedance spectroscopy (EIS) measurements for the VRFB in operation conditions. The total resistance (Rᵢₙₜ) of the system without a composite membrane (Δ) was found to be about 1.17Ω. Thus, the resistance of the composite membrane (Rₘ) was estimated by comparing the Rim values obtained with and without the carbon-supported ZSM-5 membrane mounted in the single cell. The total resistance of the VRFB cell equipped with the carbon-supported ZSM-5 membrane (O) was found to be about 1.27Ω and was much smaller than that of a commercial VRFB equipped with a 183 μm thick Nafion® 117 membrane (□), which was found to be about 1.98Ω, because the carbon-supported ZSM-5 membrane thickness was only about 12 μm and the ZSM-5 membrane thickness was only about 4 μm. The area-specific resistances of the carbon-supported ZSM-5 membrane and the Nafion® 117 membrane were estimated to be about 0.2 Ω·cm² and about 1.6 Ω·cm², respectively.

Charge-Discharge Curves. The charge-discharge curves of the VRFB equipped with the carbon-supported ZSM-5 membrane were measured at room temperature at various current densities. The negative and positive electrolyte solutions used in the experiments were 8 ml of 2 M V²⁺/V³⁺sulfate solution in 2M H₂SO₄ and 8 ml of 2 M V⁵⁺/V⁴⁺(VO²⁺/VO²⁺) sulfate solution in 2M H₂SO₄, respectively. The following are reactions on the two electrodes when discharging, where the potentials are based on standard hydrogen electrode (SHE) reference, and the reactions reverse during charging process:

anode: V²⁺→V³⁺+e⁻(E=−0.26 V)

cathode: VO₂⁺+e⁻+2H⁺→VO²⁺+H₂O (E=+1.00 V)

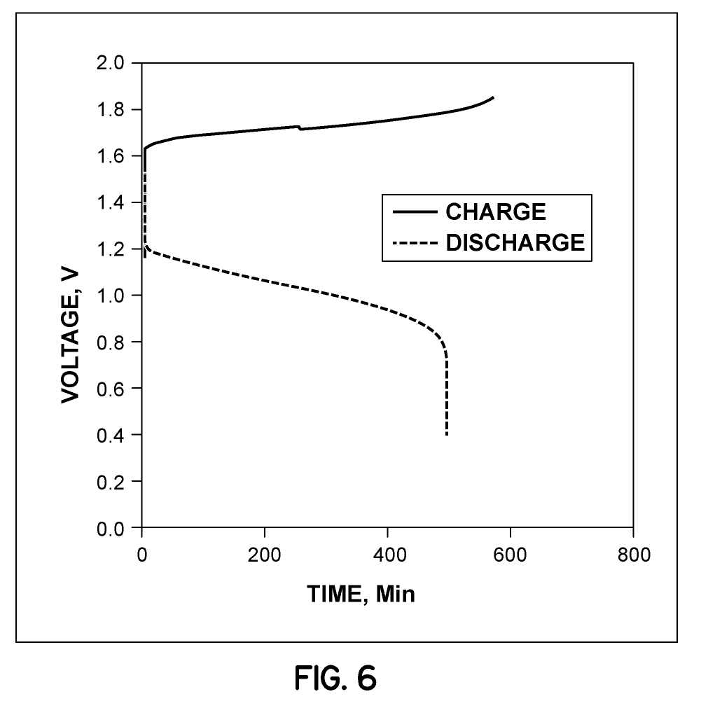

FIG. 6 shows the results of charge-discharge measurement for the VRFB with the carbon-supported ZSM-5 membrane. At a current density of 40 mA/cm², the Coulumbic efficiency and voltage efficiency are 90% and 59%, respectively. The relatively low voltage efficiency is likely primarily caused by activation loss due to carbon surface contamination during the hydrothermal secondary growth process and consequent electrode deactivation. This carbon surface contamination may be resolved by post-synthesis loading of graphite nanoplates, by post-synthesis washing by base solution to remove the amorphous aluminosilicate deposits on internal carbon surface, or by using the contamination free “vapor phase transport” synthesis method for zeolite membrane formation.

While specific embodiments have been described in considerable detail to illustrate the present invention, the description is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A redox flow battery comprising:
a first oxidizing reaction chamber;
a second reducing reaction chamber; and
a separator dividing said first oxidizing reaction chamber and said second reducing reaction chamber, said separator comprising a zeolite layer fixed to a support layer, said support layer comprising a porous substrate that is a carbon substrate or a carbon coated substrate.

2. The redox flow battery of claim 1, wherein said carbon coated substrate is coated with a carbon material selected from a group consisting of activated carbon, graphite nanoplates, carbon nanotubes, carbon nanofibers, graphene, and mixtures thereof.

3. The redox flow battery of claim 1, wherein said porous substrate is coated with an electrochemical catalyst.

4. The redox flow battery of claim 1, wherein said porous substrate includes a porous support layer selected from a group consisting of metals, ceramics, metalloids, and polymers.

5. The redox flow battery of claim 1, wherein said porous substrate comprises a carbon cloth coated with graphite nanoplate particles.

6. The redox flow battery of claim 1, wherein said support layer is an electrode.

7. The redox flow battery of claim 1, wherein said redox flow battery is one of a vanadium battery, a zinc-cerium battery, a zinc-bromine battery, an iron-chromium battery, a vanadium-bromine battery, a sodium-polysulfide-bromine battery, and an all-vanadium battery.

8. A separator for a redox flow battery comprising:
a support layer having a first side, said support layer comprising a porous substrate that is a carbon substrate or a carbon coated substrate; and
a zeolite layer formed on the first side of the support layer.

9. The separator of claim 8, wherein said carbon coated substrate is coated with a carbon material selected from the group consisting of activated carbon, graphite nanoplates, carbon nanofibers, carbon nanotubes, graphene, and mixtures thereof.

10. The separator of claim 8, wherein said porous substrate is coated with an electrochemical catalyst.

11. The separator of claim 8, wherein said porous substrate includes a porous support layer selected from the group consisting of metals, ceramics, metalloids, and polymers.

12. The separator of claim 8, wherein said porous substrate comprises a carbon cloth coated with graphite nanoplate particles.

13. The separator of claim 8, wherein said support layer is an electrode.
